(19) United States
(12) Patent Application Publication
(10) Pub. No.: US 2016/0320558 A1
(43) Pub. Date: Nov. 3, 2016

(54) METHOD FOR MANUFACTURING A TREATED OPTICAL FIBER FOR RADIATION-RESISTANT TEMPERATURE SENSOR

(71) Applicants: AREVA, Courbevoie (FR); CENTRE NATIONAL DE LA RECHERCHE SCIENTIFIQUE (C.N.R.S.), Paris (FR); UNIVERSITE JEAN MONNET SAINT ETIENNE, Saint-Etienne (FR)

(72) Inventors: Jocelyn PERISSE, LYON (FR); Adriana MORANA, SAINT-ETIENNE (FR); Emmanuel MARIN, SAINT ETIENNE (FR); Jean-Reynald MACÉ, PALAISEAU (FR); Sylvain GIRARD, SAINT GENEST-LERPT (FR)

(21) Appl. No.: 15/104,522

(22) PCT Filed: Dec. 16, 2014
(86) PCT No.: PCT/EP2014/077987

§ 371 Date: Jun. 14, 2016

(30) Foreign Application Priority Data
Dec. 16, 2013 (FR) 13 62691

(51) Int. Cl. G02B 6/02; C03C 25/62; B23K 26/00; C03B 25/00

(52) U.S. Cl. CPC G02B 6/02128; G02B 6/02185; C03B 25/00; C03C 25/6233; B23K 26/0006; B23K 2203/54

(57) ABSTRACT

A method for manufacturing a treated optical fiber for a temperature sensor is provided. The method includes a) obtaining an optical fiber from pure silica or doped by one or more elements from among fluorine and nitrogen, b) imprinting, using a femtosecond laser, at least one Bragg grating in the optical fiber to obtain an imprinted fibe, the Bragg grating extending longitudinally in a portion of the imprinted fiber and being suitable for reflecting light waves propagating along the imprinted optical fiber, the laser having a power greater than or equal to 450 mW, and c) annealing at least the imprinted fiber portion to obtain the treated optical fiber.

The present invention relates to a method for manufacturing a treated optical fiber for a temperature sensor, wherein at least one Bragg grating is imprinted in the fiber using a laser, the Bragg grating extending longitudinally in a portion of the fiber and being suitable for reflecting light waves propagating along the imprinted optical fiber.

The invention also relates to the use of such a treated optical fiber in a temperature sensor.

### BACKGROUND

It is known to use optical fibers including a Bragg grating (FPG, Fiber Bragg Grating) optical fibers to measure a temperature. The Bragg grating is made up of a periodic disruption of the refraction index of the core of the fiber along the axis of the fiber. The light propagating in the core of the fiber with a broadband spectrum is reflected by the grating around a certain wavelength, called “Bragg wavelength”, which depends on the pitch of the grating. The Bragg wavelength varies as a function of the temperature of the Bragg grating, with a sensitivity for example of about 10 pm/° C.

Bragg grating optical fiber sensors do not require a local power source, and are not sensitive to electromagnetic disruptions. They allow an offset over large distances between a measuring point and a processing point of the measurement, as well as multiplexing of a large number of measuring points on a same fiber. They are also not very intrusive, and have a null intrinsic drift.

### SUMMARY OF THE INVENTION

However, despite these interesting properties, the optical fiber sensors of the state of the art show their limits in harsh environments in terms of temperatures and radiation. For high temperatures, for example above 300° C., and for doses of radiation exceeding several tens of kGy (kilogray), a gradual loss of the measurement occurs by erasure of the Bragg grating, and/or an offset of the Bragg wavelength causing a drift of the measurement, and/or a loss of transmission of the optical fiber.

One aim of the invention is therefore to provide a method for manufacturing a treated optical fiber for a temperature sensor, the fiber being capable of withstanding higher temperatures and stronger doses of radiation.

To that end, the invention provides a method for manufacturing a treated optical fiber for a temperature sensor, comprising at least the following steps:
a) obtaining an optical fiber,
b) imprinting, using a femtosecond laser, at least one Bragg grating in the optical fiber to obtain an imprinted fiber, the Bragg grating extending longitudinally in a portion of the imprinted fiber and being suitable for reflecting light waves propagating along the imprinted optical fiber, the laser having a power greater than or equal to 450 mW, and
c) annealing at least the imprinted fiber portion to obtain the treated optical fiber.

According to specific embodiments, the method includes one or more of the following features, considered alone or according to any technically possible combination(s):

step b) for imprinting using the laser has a duration greater than or equal to 30 seconds;

in step a), the obtained optical fiber is a single-mode fiber;

in step a), the obtained optical fiber is an optical fiber with a pure silica core or doped by one or more elements from among fluorine and nitrogen;

in step b), the laser emits pulses, each pulse having a width less than or equal to 150 femtoseconds;

in step a), the optical fiber includes a core with a diameter comprised between 2 micrometers and 20 micrometers;

in step b), during the imprinting, the optical fiber is stretched by a weight of 4 grams to 300 grams fixed on the optical fiber;

during the annealing step c), the imprinted fiber is brought to an annealing temperature greater than or equal to 500° C., for at least 15 minutes;

the method further comprises a step for determining a maximum usage temperature of the treated optical fiber as a component of the temperature sensor, and during the annealing step c) (140), the imprinted fiber (135) is brought to an annealing temperature, the difference between the annealing temperature and the maximum usage temperature being comprised between 100° C. and 200° C.

The invention also provides a use of at least one treated optical fiber obtained using a method as described above in a temperature sensor.

### BRIEF SUMMARY OF THE DRAWINGS

The invention will be better understood upon reading the following description, provided solely as an example and done in reference to the appended drawings, in which:

FIG. 1 is a diagrammatic view of a temperature sensor according to an embodiment of the invention, including a treated optical fiber obtained using a method according to an embodiment of the invention,

FIG. 2 is a graph illustrating the evolution of the Bragg wavelength of the Bragg grating of the treated optical fiber shown in FIG. 1 as a function of the evolution of the temperature to which the Bragg grating is subjected,

FIG. 3 is a diagram showing the main steps of a method according to an embodiment of the invention suitable for manufacturing the treated optical fiber shown in FIG. 1,

FIG. 4 is a graph illustrating the effect of different annealing temperatures on the Bragg peak of the Bragg grating of an optical fiber similar to that shown in FIG. 1,

FIG. 5 is a graph illustrating a shift of the Bragg wavelength of the Bragg grating of an optical fiber similar to that shown in FIG. 1 during two successive radiation phases,

FIG. 6 is a graph illustrating the effect of the annealing step of the treatment illustrated in FIG. 3 on the amplitude of the Bragg peak of a grating in a reference optical fiber obtained using a method different from that of embodiments of the invention, and

FIG. 7 is a graph illustrating the effect of two successive radiations on a fiber obtained using a method similar to that according to an embodiment of the invention, but whereof the annealing temperature differs from that of embodiments of the invention

### DETAILED DESCRIPTION

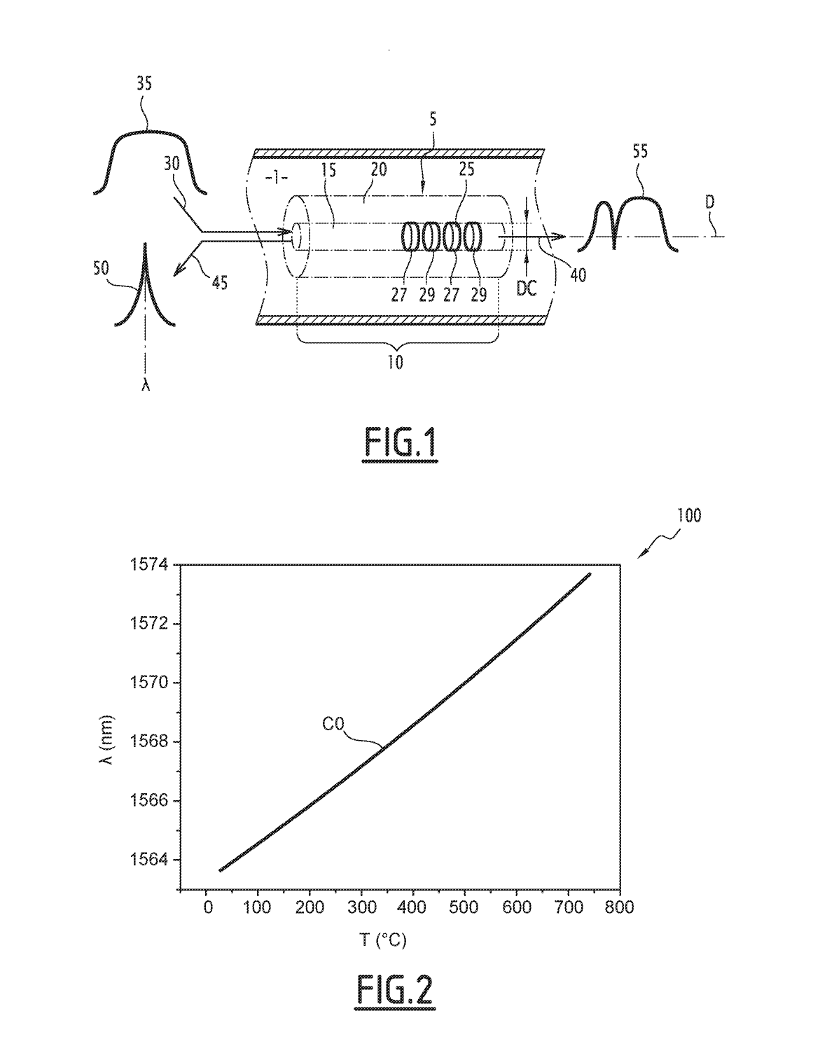

In reference to FIG. 1, a temperature sensor 1 according to an embodiment of the invention is described. The temperature sensor 1 comprises a treated optical fiber 5.

The temperature sensor 1 is for example intended to be placed in a nuclear reactor. For example, the sensor 1 is used to measure the temperature of a heat transfer fluid, such as the water of the primary cooling circuit of a pressurized water reactor, or the liquid sodium of a fast-neutron reactor, or a facility for manufacturing or storing highly active nuclear waste.

For simplicity, only a portion 10 of the treated optical fiber 5 extending along an axis D is shown in FIG. 1.

The treated optical fiber 5 comprises a core 15, a peripheral part 20, sometimes called optical sheath, surrounding the core 15 around the axis D, and a Bragg grating 25 situated in the core 15.

Alternatively, the treated optical fiber 5 comprises several Bragg gratings similar to the Bragg grating 25.

The treated optical fiber 5 is for example a pure silica fiber or a doped fiber, for example by fluorine and/or nitrogen. The treated optical fiber 5 is a single-mode fiber at the Bragg wavelength of the Bragg grating 25.

“Doped by an element” means that the core or the sheath of the doped fiber comprise at least 10 ppm of that element.

The core 15 has a diameter DC for example comprised between 2 μm and 20 μm.

The Bragg grating 25 comprises alternating portions 27 and portions 29 along the axis D, the portions 29 for example having a refraction index higher than the refraction index of the portions 27. For simplicity, only two portions 27 and two portions 29 are shown in FIG. 1.

As shown in FIG. 1, to make the Bragg grating 25 of the treated optical fiber 5 operate, a light signal 30 is sent into the treated optical fiber 5. The light signal 30 for example comprises a range of wavelengths symbolized by the curve 35.

The light signal 30 travels along the treated optical fiber 5 up to the Bragg grating 25, which sends a transmitted light signal 40, and reflects a reflected light signal 45.

The reflected light signal 45 includes a range of wavelengths 50 having the form of a peak, called “Bragg peak”. The Bragg peak is centered on a wavelength λ called “Bragg wavelength” of the Bragg grating 25.

The transmitted light signal 40 comprises a range of wavelengths 55 corresponding to the range of wavelengths 35 minus the range of wavelengths 50.

FIG. 2 is a graph 100 including a curve C0 giving the evolution of the Bragg wavelength λ, in nanometers, as a function of the temperature T, in degrees Celsius, seen by the Bragg grating 25 of the treated optical fiber 5 shown in FIG. 1.

Thus, from the range of wavelengths 50, it is possible to determine the Bragg wavelength λ (FIG. 1), then to determine the temperature T using the curve C0 (FIG. 2). The sensitivity is approximately 10 pm/° C.

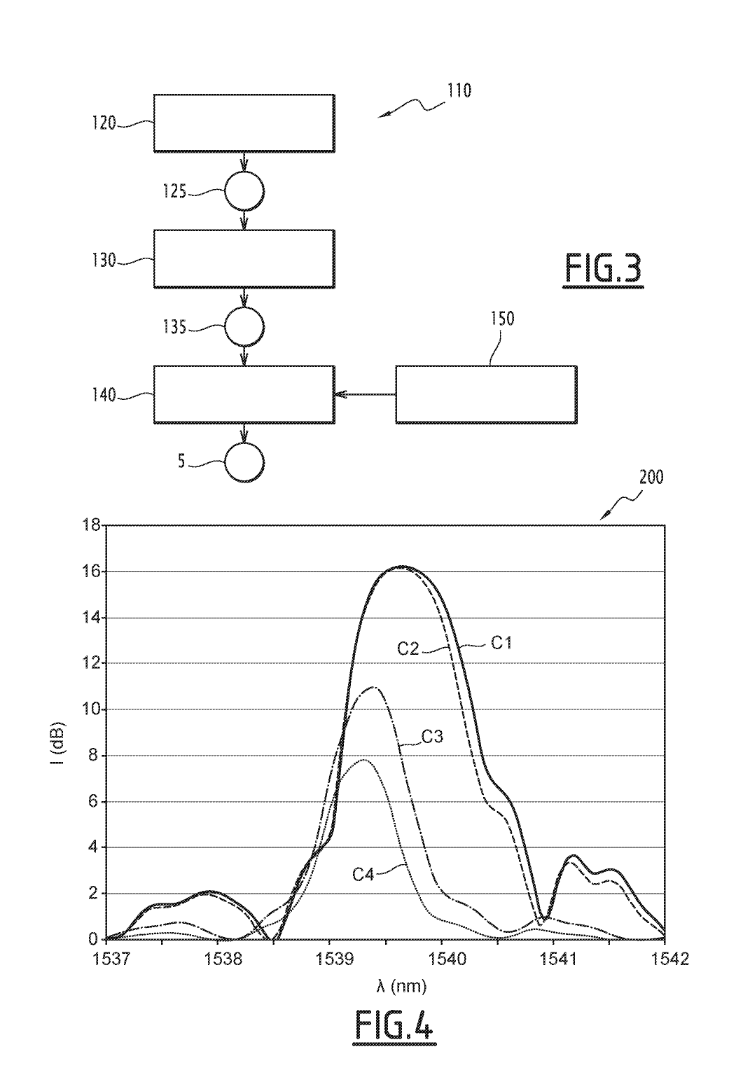

In reference to FIG. 3, a method 110 according to an embodiment of the invention will now be described.

The method 110 makes it possible to manufacture the treated optical fiber 5 shown in FIG. 1, suitable for the temperature sensor 1.

The method 110 comprises a step 120 for obtaining an optical fiber 125, a step 130 for imprinting a Bragg grating in the optical fiber 125 to obtain an imprinted fiber 135 including the Bragg grating 25, and a step 140 for annealing at least a portion of the imprinted fiber 135, to obtain the treated optical fiber 5.

Alternatively, in step 130, several Bragg gratings are imprinted in the optical fiber 125.

In step 20, the obtained optical fiber 125 is for example a single-mode fiber, of pure silica or advantageously doped by one or more elements chosen from among fluorine and/or nitrogen.

Optionally, the method 110 further comprises a step 150 for determining a maximum usage temperature of the treated optical fiber 5 as component of the temperature sensor 1.

In step 130, the longitudinal portion of the obtained fiber 125 is stripped, in which the Bragg grating 25 is imprinted. The imprinting is done using a femtosecond laser, for example using the traditional phase mask technique. The focusing of the femtosecond laser is done with a cylindrical lens with a short focal length, for example from twelve to nineteen millimeters.

“Femtosecond laser” refers to a laser that produces pulses having a duration of approximately several femtoseconds to several hundreds of femtoseconds.

The laser advantageously has an average power greater than or equal to 450 mW. The laser emits pulses, each pulse having a width less than or equal to 150 femtoseconds. The laser for example has a wavelength of 800 nm.

During the imprinting step 130, the optical fiber 125 is advantageously stretched by a weight from 6 to 8 grams fastened on the optical fiber.

In step 140, according to a first embodiment, the imprinted fiber 135 is for example brought to an annealing temperature greater than or equal to 500° C., for at least fifteen minutes.

According to another embodiment, in step 140, the imprinted fiber 135 is brought to an annealing temperature, the difference between the annealing temperature and the maximum usage temperature determined in step 150 being comprised between 100° C. and 200° C. For example, the maximum usage temperature is 600° C., and the annealing temperature is 750° Celsius.

As a function of the exposure parameters used (duration of the pulses, power of the femtosecond laser), the Bragg grating 25 of the imprinted optical fiber 135 is next more or less erased by the annealing step 140. The exposure parameters are determined to have Bragg gratings that are stable at the usage temperature of the treated optical fiber 5 and having interesting performance levels in terms of resistance to radiation.

The radiation tests have shown that the resistance of the Bragg grating 25 to radiation increases with the annealing temperature. For example, when the annealing temperature is 750° C., the Bragg grating 25 has a shift (BWS) of its Bragg wavelength under radiation smaller than the shift obtained when the annealing temperature is 350° C. Furthermore, when the annealing temperature is 750° Celsius, no erasure phenomenon of the Bragg grating 25 is observed under radiation.

FIG. 4 is a graph 200 illustrating the effect of the annealing temperature on the Bragg peak. The graph 200 comprises four curves C1, C2, C3 and C4.

The curve C1 represents the Bragg peak of the Bragg grating 25 in the absence of the annealing step 140.

The curves C2, C3 and C4 respectively show the Bragg peak of the Bragg grating 25 obtained for annealing temperatures respectively equal to 300° C., 550° C. and 750° C. The Bragg grating is obtained from a fiber with a silica core doped with fluorine, imprinted using a femtosecond laser with a mean power of 500 mW and a wavelength equal to 800 nm.

Each curve C1 to C4 gives the evolution of the intensity of the reflected light signal 45, in decibels, as a function of the wavelength in nanometers. Each curve C1 to C4 is similar to the range of wavelengths 50 shown in FIG. 1.

One can see that the gradual rise of the annealing temperature causes an attenuation of the Bragg peak, as well as a shift of the Bragg wavelength λ toward the shorter wavelengths.

FIG. 5 is a graph 300 illustrating the resistance to radiation of the Bragg grating 25 of the treated optical fiber 5 obtained using the same method as for the graph 200, with an annealing temperature of 750° C.

The graph 300 comprises a curve C5 illustrating the evolution, as a function of the time t in seconds, of part of the shift Δλ of the Bragg wavelength in nanometers, and on the other hand of the error ET, in degrees Celsius, committed on the measured temperature.

The shift Δλ is read on the left y-axis of the graph 300, while the error ET is read on the right y-axis of the graph 300.

During a first phase A, lasting approximately 30,000 seconds, the Bragg grating 25 of the treated optical fiber 5 is radiated at a constant dose rate. The dose received at the end of the first phase A is 1.5 MGy (megagray).

In a second phase B lasting approximately 60,000 seconds, the radiation of the Bragg grating 25 is stopped.

In a third phase C lasting about 30,000 seconds again, the Bragg grating 25 is radiated under the same conditions as in the first phase A, i.e., it again receives a dose equal to 1.5 MGy.

In the first phase A, the Bragg wavelength begins by decreasing by four pm (picometers), then increases again by about twelve pm gradually during the first phase A. This drift of the Bragg wavelength corresponds to an error ET1 (FIG. 5) on the temperature measured by the sensor 1 of approximately 0.4° C.

During the second phase B, the Bragg wavelength decreases abruptly to stabilize at about twelve pm below the initial value.

During the third phase C, the Bragg wavelength rises abruptly substantially to the value that it had at the end of the first phase A and remains relatively stable throughout the entire third phase C. The drift of the Bragg wavelength during the third phase C corresponds to an error ET2 on the measured temperature of about 0.4° C. Thus, one sees that the Bragg grating 25 of the treated optical fiber 5 has a very good radiation resistance, even after two radiations corresponding to a dose of 3 MGy.

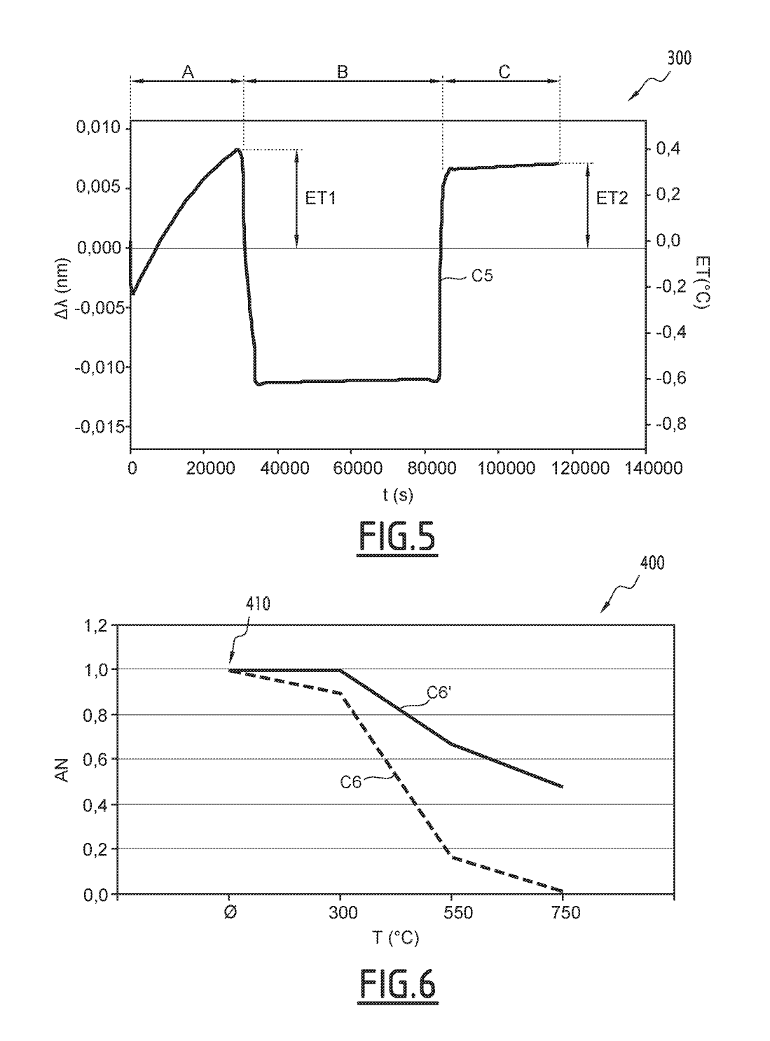

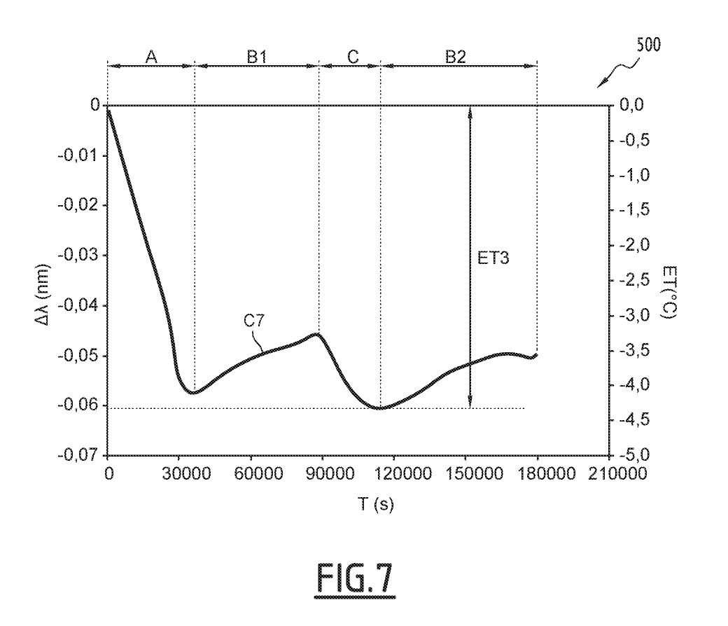

FIGS. 6 and 7 illustrate the result of parametric studies conducted to determine the impact of noncompliance with one of the steps of the method 110.

FIG. 6 is a graph 400 including a curve C6 illustrating the effect of the annealing temperature T in degrees Celsius (on the x-axis) on the normalized amplitude AN (on the y-axis) of the Bragg peak of the Bragg grating 25 when the imprinting step 130 has been carried out using a femtosecond laser with a power of 400 mW, instead of 500 mW as in FIG. 4.

The curve C6 comprises a first point 410 giving the amplitude of the Bragg peak in the absence of an annealing step. The amplitude is then 16 dB and corresponds to the maximum of the curve C1 in FIG. 4. This amplitude of 16 dB is normalized at 1.0 on the graph 400 of FIG. 6.

Then the curve C6 shows the gradual reduction of the normalized amplitude AN of the Bragg peak when the annealing temperature T is respectively 300° C., 550° C. and 750° C.

The curve C6′ also shows the gradual reduction of the normalized amplitude AN of the Bragg peak when the annealing temperature T is respectively 300° C., 550° C. and 750° C., when the imprinting step 130 is done using a femtosecond laser with a power of 500 mW.

One can see on the curve C6 that at 750° C., the amplitude of the Bragg peak becomes practically null, since the Bragg grating 25 is erased.

On the contrary, as shown in FIG. 4 and on curve C6′, surprisingly, when the power of the laser is 500 mW, the amplitude of the Bragg peak goes from sixteen decibels without the annealing step to 8 decibels in the presence of an annealing step 140 at an annealing temperature of 750° C. This demonstrates the existence of a power threshold of the laser, situated at 450 mW, from which the obtained Bragg grating 25 withstands annealing at 750° C.

It is considered that the Bragg grating 25 withstands the annealing if the normalized amplitude AN remains above a threshold of 0.2 for example, i.e., if the attenuation of the amplitude of the Bragg peak is less than 7 dB in the example shown in FIG. 6.

FIG. 7 shows a graph 500 similar to the graph 300 shown in FIG. 5. The graph 500 includes a curve C7 illustrating the resistance to radiation of a Bragg grating 25 obtained at the end of an imprinting step 130, in which the power of the laser is 500 mW, and an annealing step 140 at a temperature below 500° C.

Phases A, B1 and C of the graph 500 are similar to phases A, B and C of the graph 300.

The graph 500 includes an additional phase B2 corresponding to stopping the radiation after phase C.

As can be seen in the graph 500, the Bragg wavelength λ of the Bragg grating 25 is much more sensitive to the two radiation phases A and C than under the conditions of the graph 300 of FIG. 5. In particular, at the end of the third phase C corresponding to a second radiation, the shift of the Bragg wavelength due to the radiation is −60 μm. This corresponds to an error ET3 on the measured temperature equal to about 4.5° C.

Owing to the described features, the manufacturing method 110 makes it possible to obtain a treated optical fiber 5 including a Bragg grating 25 capable of better withstanding doses of radiation above 1 MGy, and therefore of withstanding stronger doses of radiation than the optical fibers of the state of the art.

Furthermore, the optional feature according to which the imprinted fiber 135 is brought to an annealing temperature greater than or equal to 500° C. for at least fifteen minutes makes it possible to obtain a Bragg grating 25 subsequently capable of withstanding a usage temperature of up to about 550° C.

Likewise, the optional feature according to which, during the annealing step 140, the imprinted fiber 135 is brought to an annealing temperature makes it possible to obtain a Bragg grating 25 capable of withstanding a usage temperature equal to the annealing temperature minus a value comprised between 100° C. and 200° C.

The power of the laser is expressed by a formula independent from the size of the beam and the length of the Bragg grating 25.

The set of elements to compute the power density can be summarized by the following formula:

$$D = \frac{2 π E \times A \times p}{4 \times f \times λ \times t}$$

where:

D is the power density (in W/cm²) deposited by the laser,

E is the pulse energy of the laser (in J) that is deduced from the power of the laser (in W) by dividing by the frequency of the pulses (in Hz),

A is a parameter related to the position of the fiber relative to the phase mask (A=1),

p is the energy fraction to the first order (equal to 73%),

λ, is the wavelength of the femtosecond laser (in cm),

f is the focal length of the objective lens (cm), and

t is the duration of the pulse (in s).

The power threshold of the laser of 450 mW therefore corresponds to a minimum power density of 2.3.10¹³ W/cm², with A=1, f=19 mm, λ=800 nm and f=150 fs.

1-10. (canceled)

11. A method for manufacturing a treated optical fiber for a temperature sensor, comprising at least the following steps:
a) obtaining an optical fiber, the obtained optical fiber being an optical fiber of pure silica or doped by one or more elements from among fluorine and nitrogen;
b) imprinting, using a femtosecond laser, at least one Bragg grating in the optical fiber to obtain an imprinted fiber, the Bragg grating extending longitudinally in a portion of the imprinted fiber and being suitable for reflecting light waves propagating along the imprinted optical fiber, the laser having a power greater than or equal to 450 mW; and
c) annealing at least the imprinted fiber portion to obtain the treated optical fiber.

12. The method according to claim 11 wherein step b) for imprinting using the laser has a duration greater than or equal to 30 seconds.

13. The method according to claim 11 wherein, in step a), the obtained optical fiber is a single-mode fiber.

14. The method according to claim 11 wherein, in step b), the femtosecond laser is focused with a cylindrical lens with a short focal length, from twelve to nineteen millimeters.

15. The method according to claim 11 wherein, in step b), the laser emits pulses, each pulse having a width less than or equal to 150 femtoseconds.

16. The method according to claim 11 wherein, in step a), the obtained optical fiber includes a core with a diameter comprised between 2 micrometers and 20 micrometers.

17. The method according to claim 11 wherein, in step b), during the imprinting, the optical fiber is stretched by a weight of 4 grams to 300 grams fixed on the optical fiber.

18. The method according to claim 11 wherein during the annealing step c), the imprinted fiber is brought to an annealing temperature greater than or equal to 500° C., for at least 15 minutes.

19. The method according to claim 11 further comprising a step of determining a maximum usage temperature of the treated optical fiber as a component of the temperature sensor, during the annealing step c), the imprinted fiber being brought to an annealing temperature, the difference between the annealing temperature and the maximum usage temperature being comprised between 100° C. and 200° C.

20. At least one treated optical fiber for a temperature sensor obtained using the method according to claim 11.
